(19) United States
(12) Patent Application Publication
(10) Pub. No.: US 2018/0135582 A1
(43) Pub. Date: May 17, 2018

(54) INJECTOR CUP ASSEMBLY

(71) Applicant: Continental Automotive GmbH, Hannover (DE)

(72) Inventors: Andrea PUCCINI, San Miniato (PI) (IT); Giandomenico SERRA, Ghezzano - S. Giuliano Terme (PI) (IT)

(21) Appl. No.: 15/737,408

(22) PCT Filed: May 18, 2016
(86) PCT No.: PCT/EP2016/061162

§ 371 Date: Dec. 18, 2017

(30) Foreign Application Priority Data
Jun. 22, 2015 (EP) 15173057.9

(51) Int. Cl. F02M 61/14

(52) U.S. Cl. CPC F02M 61/14; F02M 2200/856; F02M 2200/855

(57) ABSTRACT

A fuel injector cup assembly has an injector cup, at least one bolt and an elastic element which mechanically couples the injector cup to a cylinder head. The bolt (7) is arrangeable through a penetrating first opening of the injector cup and in an opening of the cylinder head to fasten the injector cup to the cylinder head. The elastic element is configured to be mechanically coupled to the injector cup at a given position to act against a tilt of the injector cup relative to the cylinder head.

### BACKGROUND

The invention relates to an assembly for mechanically coupling an injector cup to a cylinder head of a combustion engine, to an injector cup assembly, a fuel rail assembly, a fuel injection assembly and to an internal combustion engine.

Injectors are in widespread use in particular for internal combustion engines where they may be arranged in order to dose a fluid into an intake manifold of the internal combustion engine or directly into a combustion chamber of a cylinder of the internal combustion engine.

In general, injectors of a combustion engine are coupled to an injector cup, which itself is coupled to a cylinder head and to a fuel rail for supplying the injectors with fuel for example. Because of forces generated during an operation of the combustion engine, the injector cup needs to be fixed to the cylinder head to ensure a correct position of the nozzle tip of the injector inside a combustion chamber. In addition, there is a need for a clamping force between the injector and the fuel rail that prevents or at least decreases a relative movement of the injector cup in reference to the cylinder head due to an operation of the injector and the combustion engine. For example a streaming fluid generates a dynamic force that tends to lift the injector cup in an upwards direction and hence stresses the fuel rail and other components coupled to the injector cup.

In case of a single fixing point for example sideways of the injector, the dynamic force leads to a leverage or upper force which amongst others causes movement of the injector cup. Depending on a position of the fixing point and a configuration of a fixing element, the generated leverage or upper force may result in a more or less upward movement of the injector cup, bending the injector cup around the fixing point.

### SUMMARY

One object of the invention is to create an injector cup assembly which facilitates a reliable and precise function and enhances a stability of the injector cup by means of reducing undesirable movement of the injector cup and/or components coupled thereto.

The object is achieved by the features of the independent claim. Advantageous embodiments of the invention are given in the dependent claims.

According to a first aspect of the invention, an assembly for mechanically coupling an injector cup to a cylinder head of a combustion engine comprises at least one bolt and an elastic element. According to a further aspect, an injector cup assembly comprising the injector cup, and further comprising the at least one bolt and the elastic element for mechanically coupling the injector cup to a cylinder head of a combustion engine is specified. The injector cup may expediently be configured for receiving an injector, in particular a fuel injector of an internal combustion engine. In particular, the injector cup is configured for being shifted over a fuel inlet end of the injector.

According to another aspect, a fuel rail assembly comprising the injector cup assembly and a fuel rail is specified. According to yet another aspect, a fuel injection assembly comprising the fuel rail assembly and the fuel injector which is received in the injector cup is specified.

According to yet another aspect, an internal combustion engine comprising the cylinder head and the fuel injection assembly is specified. Preferably, the engine has a combustion chamber which is delimited by the cylinder head in some places. The injector may be exposed to the combustion chamber. In particular, it extends through the cylinder head into the combustion chamber.

The injector cup has a longitudinal axis. The bolt is arrangeable through a penetrating first opening of the injector cup and in an opening of the cylinder head to fasten the injector cup to the cylinder head. The elastic element is configured to be mechanically coupled to the injector cup at a given position to act against a tilt of the injector cup relative to the cylinder head by means of mechanical interaction with the bolt to generate a torque on the injector cup for pressing the injector cup to the cylinder head at a side opposite of the given position with respect to the penetrating first opening.

In case of the injector cup assembly, the bolt is preferably arranged so that it extends through the penetrating first opening and the elastic element is mechanically coupled to the injector cup at the given position. In case of the internal combustion engine, the injector cup is preferably fastened to the cylinder head by means of the bolt which is arranged in the opening of the cylinder head and generates the torque which presses the injector cup against the cylinder head.

This configuration of an injector cup assembly describes a simple and reliable possibility for mechanically coupling the injector cup to the cylinder head for a combustion engine. The elastic element enables fixation of the injector cup to the cylinder head to enhance stability and decrease an uncontrolled movement of components coupled to the injector cup, such as the fuel rail or a pipe between the injector cup and the fuel rail.

In one embodiment, the injector cup comprises a penetrating second opening for receiving the injector. The penetrating second opening is preferably positioned at said side opposite of said given position. In other words, the penetrating first opening is positioned between the given position and the penetrating second opening, in particular in a direction perpendicular to the longitudinal axis. To put it differently, the elastic element is arrangeable at an opposite side to the second opening of the injector cup with respect to the bolt.

Such an arrangement of the injector cup, the elastic element and the bolt describes an advantageous embodiment to enable a reliable and certain function of the injector and the combustion chamber. During an operation of the combustion engine and the injector, a streaming fluid causes a hydraulic force that tends to lift the injector cup upward for example. Therefore, the elastic element is configured to generate a force and—by means of its position and interaction with the injector cup and the bolt—a torque or bending moment to counteract the hydraulic force to equilibrate a bending moment and a resulting undesirable movement of the injector cup and hence enables a reliable function of the injector.

With reference to the bolt and the penetrating first opening, the second opening of the injector cup is arranged at an opposite side compared to given position of the elastic element which enables beneficial performances to compensate the dynamic force generated in the area of the second opening by the static force generated by the elastic element. In particular, the torque generated by the elastic element and a second torque which is generated by the hydraulic force on the injector cup around the fulcrum region where the bolt fixes the injector cup to the cylinder head have opposite rotational directions. Therefore, the torque generated by the elastic element counteracts the second torque to limit the overall torque on the injector cup during operation. The elastic element may, thus, also be denoted as a bending moment limiter. With the injector cup assembly according to the present disclosure, the risk that the hydraulic force bends a portion of the injector cup away from the cylinder head is particularly low.

In this context, the hydraulic force is a dynamic—i.e. variable—force, depending on the pressure of the streaming fluid for example. In contrast the elastic element generates a generally constant—or “static”—force and torque to counter the dynamic force depending on a configuration of the elastic element and a material it is consisting of. The bolt is another element contributing to fixing the injector cup to the cylinder head and defines a position which acts as a leverage point for the above mentioned dynamic force. To put it differently, the fulcrum region is in particular defined by the penetrating first opening through which the bolt is arrangeable or arranged.

As a result, a leverage force generated by the dynamic force gets at least partially compensated by a leverage force generated by the static force of the elastic element. Hence, in an advantageous embodiment, the spring area of the elastic element and the given position are configured an positioned to generate a torque whose absolute value is substantially equal to the highest absolute value of the torque which is effected by the dynamic force acting on the main portion 31 of the injector cup 3, generated during an operation of the injector and the combustion engine.

In one embodiment, the injector cup has a main portion and a beam portion. The main portion has in particular the basic shape of a cylindrical shell, extending in particular along the longitudinal axis. It defines the penetrating second opening. The beam portion protrudes laterally from the main portion at one end of the main portion. The beam portion in particular represents a bracket for fixing the injector cup to the cylinder head. The penetrating first opening is preferably positioned—for example centrally—between the given position and the interface of the beam portion with the main portion.

With the injector cup assembly according to the present disclosure, there is no need to form massive structures—such as massive injector cups and in particular large-sized beam portions—to generate a force to counteract the dynamic force during an operation of the combustion engine. Furthermore, it is also not necessary to build high cost components because the elastic element is simple in design and manufacturing. The injector cup assembly may, thus, be particularly lightweight and cost-efficient.

Another advantage of the described elastic element is the ordinary positioning at the injector cup. In most instances it is independent from the dimensions of the injector cup and the cylinder head and it can be easily manufactured concerning a clearance with other engine environment components. Therefore, it is not necessary to use difficult tooling movements to arrange the elastic element to the injector cup.

The elastic element easily may, in some embodiments, facilitate a correct position of the nozzle tip of the injector during an operation of a combustion engine and hence enables a certain and reliable operation of the injector and the combustion engine.

According to one embodiment, the elastic element comprises a first section, a second section adjacent to the first section and a third section adjacent to the second section. The first section is positioned at a distance from and substantially parallel to the third section and the second section is substantially perpendicular to the first and third section. Preferably, the first and third sections have a main extension direction oblique or, preferably, perpendicular to the longitudinal axis while the second section may extend in direction of the longitudinal axis from the first to the third section. Moreover, the third section, for effecting the torque, comprises a spring area to generate an elastic force and is positioned to be arranged between the injector cup—in particular the beam portion—and the cylinder head.

In one embodiment, the third section is configured and positioned to be elastically deformed for generating the elastic force by means of fastening the injector cup to the cylinder head with the bolt. The third portion may in particular protrude longitudinally beyond the beam portion so that the spring area is compressable by means of mounting the injector cup assembly to the cylinder head with the bolt. In case of the combustion engine, it is arranged and deformed elastically between the injector cup—in particular the beam portion—and the cylinder head so that the spring area is compressed.

This embodiment describes one possible configuration of the elastic element, and especially of the third section of the elastic element, that enables the generation of a constant static force. The spring area of the third section represents a simple way to generate the elastic force and affects an absolute value of the elastic force as well as a material of the elastic element. For example the spring area comprises one or more spherically designed areas or a wavelike shape.

The positioning of the third section of the elastic element between the injector cup and the cylinder head enables a certain arrangement of the elastic element in a predetermined position. Therefore, a constant static force is generated between the injector cup and the cylinder head that pushes the injector cup upward with respect to the longitudinal axis in coaction with the fixing bolt. As a result, the other side of the injector cup is pushed downward with respect to the longitudinal axis and the bolt as a leverage point. This leads to a counteracting force to compensate the hydraulic dynamic force during an operation of the injector and the combustion engine which tends to lift the injector cup upwards, for example.

According to a further embodiment, the third section of the elastic element comprises a wave-like spring shape and a penetrating opening. In other words, the spring area is in the shape of a single turn wave spring.

This configuration describes one possibility to create an elastic element to enable a constant static force after arrangement for example between the injector cup and the cylinder head. The size of the penetrating opening of the third section influences the absolute value of the elastic force for example in addition to a choice of material and the shape of the elastic element.

According to a further embodiment the elastic element consists of bended sheet metal. As already mentioned, the choice of material of the elastic element also influences the possible static force and hence is one parameter to configure an elastic element as needed as a coupling assembly for a combustion engine. The elastic element consisting of bended sheet metal just describes one exemplary embodiment to simply configure a clamping function element for the injector cup.

According to a further embodiment, at least the first section and the third section of the elastic element at least partially contact the injector cup, in particular the beam portion. For example, the elastic element has a U-shape as its basic shape and is arranged at one end of the injector cup. In particular it may extend around an end of the beam portion remote from the main portion. In that case, the first and third sections of the elastic element at least partially contact an upper side and a bottom side of the injector cup respectively, in particular they contact longitudinally opposite surfaces of the beam portion. Such an arrangement enables an elastic force generated by the elastic element, wherein a contact between the injector cup and the second section of the elastic element is not necessary but preferable for stability reasons.

According to a further embodiment the elastic element comprises a hook section that is configured to engage a recess of the injector cup to fasten the elastic element in a predetermined position relative to the injector cup, in particular by means of a form-fit connection. Preferably, the recess is comprised by the beam portion. Expediently, it may be positioned at the bottom side of the injector cup.

This configuration of the elastic element and the injector cup describes a simple way to realize a certain positioning of these two elements. Because the hook section extends into the recess of the injector cup in an assembled condition, the elastic element is not only fixed because of a clamping force resulting from its shape. Therefore, even during an operation of the combustion engine, there will be no or at least less movement of the elastic element relative to the injector cup because of the hook section that fastens the position of these two components.

According to a further embodiment the hook section of the elastic element is arranged at an end of the third section that extends away from the second section of the elastic element.

According to a further embodiment the first section of the elastic element comprises a penetrating opening in which the bolt is arranged to block an axial movement of the bolt with respect to the longitudinal axis.

This configuration of the elastic element describes a certain arrangement of the assembly for a combustion engine, which enables the constant static force counteracting to the hydraulic dynamic force and also a capturing force for the bolt to fasten the bolt in a defined predetermined position, for example during transportation and handling of the assembly. In this context, the penetrating opening is limited by a shape of a wall of the first section which is especially configured to prevent a movement of the bolt for example. For example, the penetrating opening of the first section is in the shape of a generally circular hole having radially inwardly extending protrusions. The diameter of the circular hole is larger than the diameter of the bolt while the radial dimension of the protrusions is larger than half the difference of the diameter of the circular hole and the diameter of the bolt such that the bolt engages with the protrusions to form an interference fit when it is arranged in the penetrating opening of the first section.

Exemplary embodiments of the invention are explained in the following with the aid of schematic drawings and reference numbers. Identical reference numbers designate elements or components with identical functions.

### BRIEF DESCRIPTION OF THE FIGURES

FIG. 1 shows a schematic cross sectional view of an injector cup assembly according to a first exemplary embodiment for mechanically coupling an injector cup to a cylinder head of an internal combustion engine;

FIG. 2 shows a schematic cross sectional view of an injector cup assembly according to a second exemplary embodiment;

FIG. 3 shows a perspective view of an injector cup assembly according to a third exemplary embodiment;

FIG. 4 shows a perspective view of an exemplary embodiment of the elastic element of the injector cup assembly according to the third exemplary embodiment; and

FIG. 5 shows a perspective view of a section of an another exemplary embodiment of an elastic element.

### DETAILED DESCRIPTION

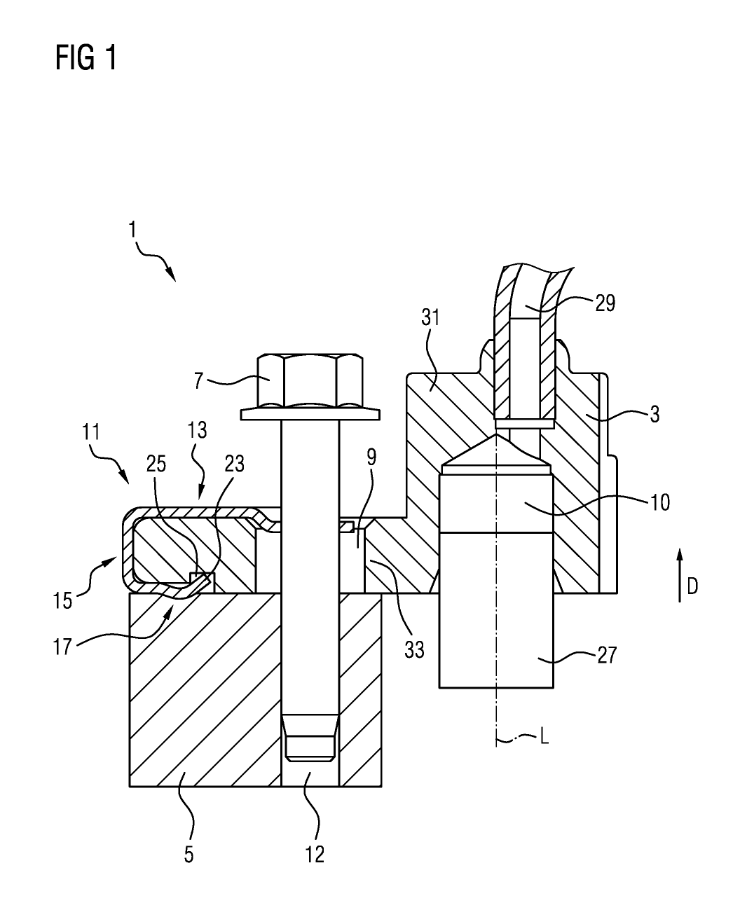

FIG. 1 shows a schematic sectional view of an internal combustion engine. The internal combustion engine has a cylinder head 5 and a fuel injection assembly. The fuel injection assembly comprises a fuel injector 27 which injects fuel such as gasoline directly into a combustion chamber of the engine. Further, the fuel injection assembly comprises a fuel rail assembly with a fuel rail (not shown in the figures), a pipe 29 assigned to each injector, the pipe 29 branching off from the fuel rail and ending in an injector cup 3. The injector cup 3 makes part of an injector cup assembly 1 of the fuel rail assembly. In addition to the injector cup 3, the injector cup assembly 1 comprises an assembly 1 for mechanically coupling the injector cup 3 to a cylinder head 5 for a combustion engine which comprises a bolt 7 and an elastic element 11.

The bolt 7 is arranged in a penetrating first opening 9 of the injector cup 3 and extends into an opening 12 of the cylinder head 5 for means of fixation of the injector cup 3 to the cylinder head 5. In the present embodiment, the first opening 9 is arranged in a beam portion 33—i.e. a bracket—of the injector cup 3.

The elastic element 11 is arranged at one end of the beam portion 33. It comprises a first section 13, a second section 15 and a third section 17. In this exemplary embodiment, the first section 13 of the elastic element 11 contacts an upper side of the beam portion 33, facing away from the cylinder head 5, and furthermore is arranged around the bolt 7 to generate a capturing force to the bolt 7 to fasten the bolt 7 in a defined and predetermined position. The second section 15 also contacts the beam portion 33 at a side surface at an end of the beam portion 33 and the third section 17 at least partially contacts a bottom side of the beam portion 33, the bottom side facing towards and contacting the cylinder head 5.

The injector cup 3 comprises a further penetrating second opening 10 in which the injector 27 is arranged. The second opening 10 is defined by a main portion 31 of the injector cup 3. The main portion 31 has a basic shape of a cylindrical shell. The second opening 10 has a first aperture at the bottom side of the injector cup 3 through which the injector 27 is shifted into the second opening 10. At the upper side of the injector cup 3, the second opening 29 has a further aperture to which the pipe 29 is connected for supplying fuel to the injector 27 through the second opening 10. The beam portion 33 projects laterally from the main portion 31 at an end of the main portion 31 which comprises the first aperture.

During an operation of the combustion engine, the injector 27 and the fuel streaming through the second opening 10 generate a dynamic force, which acts on the injector cup 3 in the region of the second opening 10 and generates a lifting force in the upward direction D. Since the injector cup 3 is only fixed to the cylinder head 5 in the fulcrum region at the first opening 9 in the beam portion 33, the lifting force results in a torque that tends to bend the main portion 31 around the fulcrum region. Such bend or lift could influence the function of the assembly 1, for example concerning an accuracy and reliability of an oscillating injector tip during an operation of the combustion engine or a long-term stability of the fuel rail assembly.

To generate a counter-torque to the torque effected by the dynamic force, it is advantageous to arrange the elastic element 11 at a given position at an side of the beam portion 33 laterally opposite of the second opening 10 with respect to the fulcrum region, i.e. the first opening 9 and the bolt 7. Hence, the elastic element 11 generates the constant static force which acts as another leverage force in reference to the bolt 7 and which compensates or at least decreases the influence of the dynamic force on the injector cup 3.

The elastic element 11 has a function of a spring to generate a constant static force on the injector cup 3 in a direction D in reference to a longitudinal axis of the bolt that extends substantially parallel to a longitudinal axis L of the injector cup 3 in a mounted configuration. Concerning this exemplary embodiment, the direction D represents an upward direction in one direction of the longitudinal axis of the bolt 7 as illustrated in FIGS. 1 to 5. The third section 17 of the elastic element 11 is arranged between the beam portion 33 and the cylinder head 5. To generate an elastic constant force, the third section 17 of the elastic element 11 has a wavelike spring shape and comprises a hook section 23, which is arranged in a recess 25 of the injector cup 3.

The constant static force is generated in a mounted configuration of the assembly 1 due to the shape and a material of the elastic element 11 or at least its third section 17. Therefore, it is not inevitably necessary that the second section 15 of the elastic element 11 contacts the injector cup 3. At least the first and the third section 13, 17 respectively contact the beam portion 33 to clamp the elastic element 11 in place so that the third section 17 can generate the constant—i.e. static—elastic force acting on the beam portion 33 at the given position in a distance from the fulcrum region. In this way, the static force, by means of interaction with the bolt 7 effects a torque on the beam portion 33 which presses the main portion 31 with the second opening 10 against the cylinder head 5. Thus, the torque acts against a tilt of the injector cup 3 relative to the cylinder head 5 which would bend the main portion 31 away from the cylinder head 5, for example due to the hydraulic force of the fuel in the second opening 10.

The hook section 23 enables in a simple way a certain positioning of the elastic element 11 to the injector cup 3. Because the hook section 23 extends into the recess 25 of the injector cup 3 in an assembled condition, the elastic element 11 is not only fixed because of a clamping force resulting from its shape. Therefore, even during an operation of the combustion engine, there will be at least less movement of the elastic element 11 relative to the injector cup 3.

Furthermore, in this exemplary embodiment of the assembly 1 in FIG. 1 a pipe 29 which branches off from the fuel rail is arranged at the upper side of the injector cup 3 to supply fuel to the injector 27 during an operation of a combustion engine.

For example, the elastic element 11 is formed from bended sheet metal having an external shape matching with the beam portion 33 so that, once inserted, it is not easy removable. As already mentioned, the elastic element 11 generates a counter-leverage force that contrasts a bending moment given by a pressure of a streaming fluid inside the injector cup 3 and limits or avoids an upward movement of the main portion 31 in reference to the upward direction D. The spring shape of the third section 17 of the elastic element 11 also absorbs and compensates any flatness error or misalignment that may be present between the cylinder head 5 and the injector cup 3.

The described assembly 1 realises a simple embodiment to reduce a movement of portions of the injector cup 3 during an operation of the combustion engine away from the cylinder head 5. Hence, there is less endangering of brazing points and O-ring sealings and no need for massive structures or high cost components to enable a similar function. Furthermore, the assembly 1 is easily manufactured and there is no or at least less issue related with dimensions or difficult tooling movements because of clearance and limited space related from other engine environment components.

The elastic element 11 in coaction with the bolt 7 realizes a simple assembly for mechanically coupling the injector cup 3 to the cylinder head 5. Depending on the requirements on other involved components of the combustion engine and on available space in the engine environment the elastic element 11 or at least the third section 17 can be manufactured from different materials and can comprise different shapes. This also influences an absolute value of the constant static force generated by the elastic element 11 in a mounted configuration of the assembly 1.

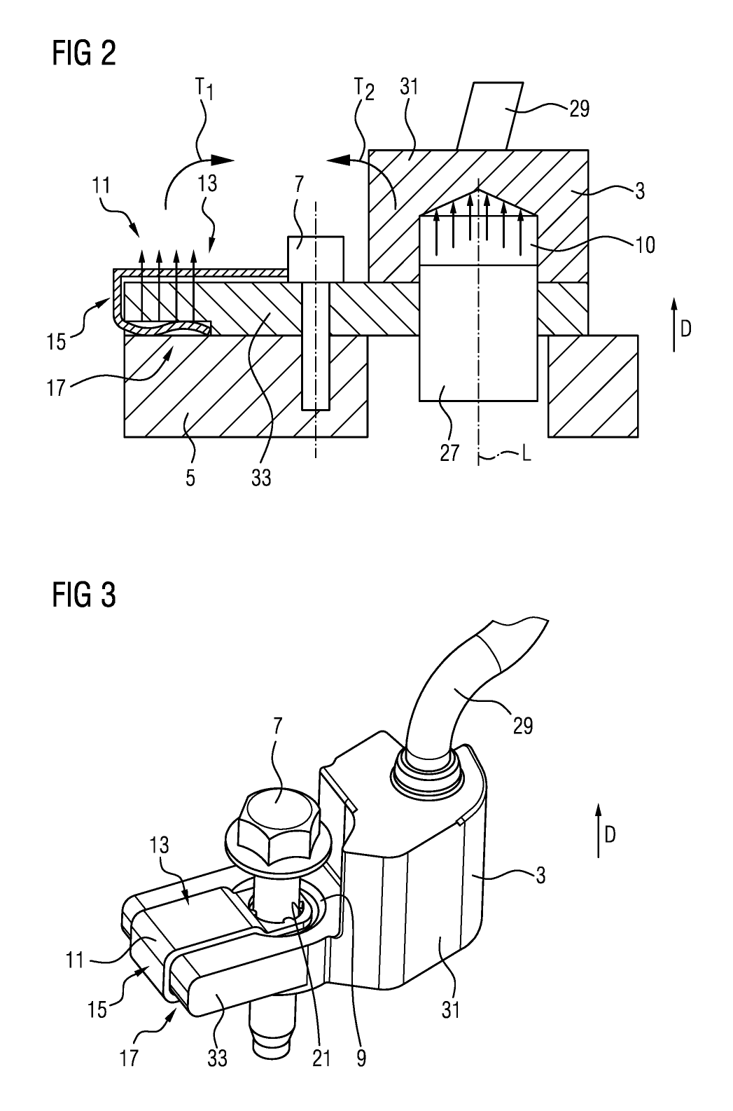

FIG. 2 describes a similar embodiment compared to the one described above in connection with FIG. 1 for reasons of illustrating the direction of generated forces by the elastic element 11 and streaming fuel during an operation of the assembly 1.

As already mentioned above, the elastic element 11 generates a constant static force resulting from the spring shape of the third section 17 in the upward direction D with respect to the longitudinal axis L. The bolt 7 fastens the injector cup 3 to the cylinder head 5 in the region of the first opening 9 in the beam portion 33 of the injector cup 3 and acts as a leverage point in the fulcrum region. The dynamic force generated by a streaming fluid during an operation of the combustion engine also acts in the upward direction D but on the side opposite of the elastic element 11 with respect to the bolt 7, i.e. the leverage point. Hence, the torque T₂ generated by the dynamic force is minimized by the counter-torque T₁ generated by the static force due to mechanical interaction with the bolt 7. This is indicated by the curved arrows in FIG. 2. Therefore, it is advantageous to configure the spring area of the elastic element 11 and the given position, to generate a torque whose absolute value is substantially equal to the highest absolute value of the torque which is effected by the dynamic force acting on the main portion 31 of the injector cup 3. The absolute value of the static force generated by the elastic element 11 depends on the material and the shape amongst others.

FIG. 3 shows a perspective view of an injector cup assembly 1 according to a third exemplary embodiment which corresponds in general to the exemplary embodiments of FIG. 1 and FIG. 2.

In this context, it is apparent that it is possible to configure one section of the elastic element 11 around the bolt 7 to fasten the bolt 7 in a desired position before assembling the injector cup assembly 1 with the cylinder head 5. In the shown embodiment, the first section 13 of the elastic element 11 comprises an opening 21 in the first section 13 of the elastic element 11. Through this opening 21 the bolt 7 is arranged to fasten the elastic element 11 to the injector cup 3 and furthermore the injector cup 3 to the cylinder head 5 (not shown in FIG. 3).

The opening 21 allows retention of the bolt 7 in a desired and predetermined position, wherein an internal shape of the opening 21 influences an axially blocking of a vertical movement of the bolt 7 for example until the assembly 1 is mounted into a combustion engine. In this context, the axially blocking and vertical movement refer to the longitudinal axis L.

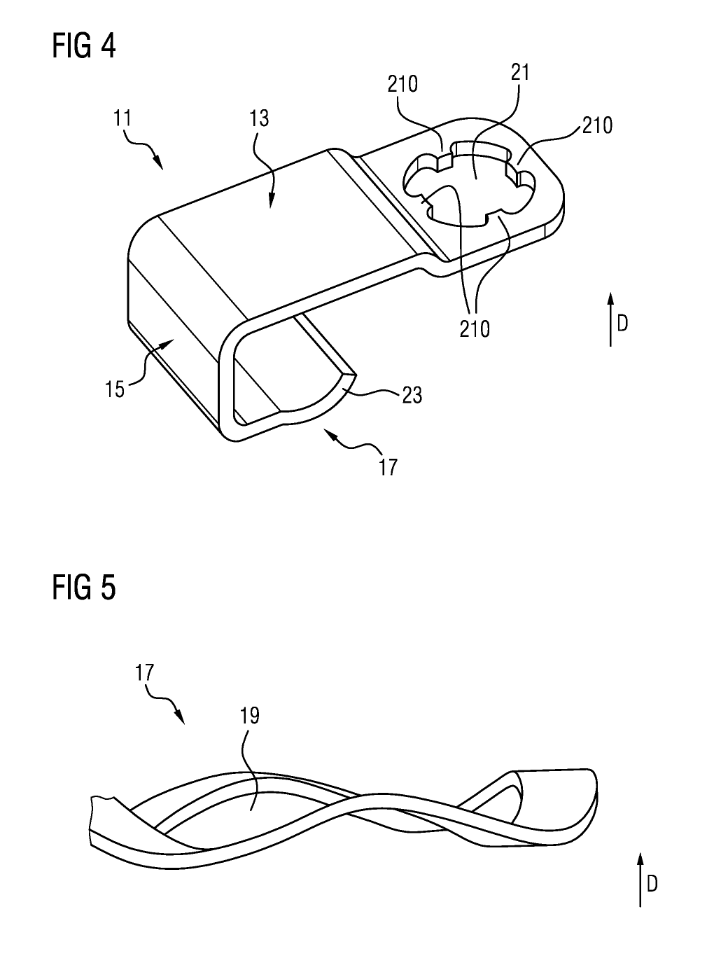

For example, the opening 21 has radially inward extending protrusions 210 which hold the bolt 7 by means of an interference fit as explained in further detail in connection with FIG. 4 below. The protrusions 210 may be configured to be deformed to allow longitudinal displacement of the bolt 7 when assembling the injector cup assembly 1 to the cylinder head 5.

Alternatively, the protrusions 210 may be arranged helically, corresponding to the thread of the bolt 7, so that the bolt 7 can be screwed to move it longitudinally relative to the elastic element 11. Preferably, the bolt 7 has an unthreaded section in this case and the unthreaded section axially overlaps the opening 21 when the injector cup assembly 1 is fixed to the cylinder head 5.

As a further alternative, the bolt 7 comprises a retainer element (not shown in the figures) which is attached to the bolt 7 before inserting the bolt 7 into the opening 21 of the first section 13 of the elastic element 11. Upon insertion of the bolt 7 through the opening 21, the retainer element is fixed to the elastic element 11, for example by means of force fit and/or friction fit. Suitable retainer elements are, for example, retainer elements which are known to the person skilled in the art as axi-rad retainers. In this case, the opening 21 is preferably tapering in longitudinal direction so that secure attachment of the retainer element is achievable.

Therefore, the elastic element 11 for example enables a function to fasten the bolt 7 and the assembly 1 during configuration and transport alternatively or additionally to threads of the bolt 7 or another element is arranged to enable a fastening function that is arranged at the bolt 7 for example.

In FIG. 4 the elastic element 11 of the embodiment described in connection with FIG. 3 is shown in more detail in a perspective view.

The elastic element 11 describes a substantially planar first section 13, a substantially planar second section 15 and a wave-like shape of the third section 17. At one end, the third section 17 comprises the hook section 23, which is arrangeable in a recess 25 of the beam portion 33 (cf. FIG. 1) to enhance fixation at a predetermined position. The shape of the opening 21 of the first section 13 of the elastic element 11—comprising the radially inward extending protrusions 210 mentioned above—enables a capturing force to the bolt 7 to hold the bolt 7 in a desired position to fasten the assembly 1. In the present embodiment, the opening 21 has four pairwise opposing protrusions 210 which are dimensioned to engage in a friction-fit connection with an unthreaded section of the bolt 7.

In FIG. 5 a further exemplary embodiment of the third section 17 of an elastic element 11 is illustrated, which again describes a wave-like spring shape as in the previous embodiment but also comprises an opening 19. The remaining portions of the elastic element 11 may for example correspond to those described above.

The shape of the third section 17 and the possible opening 19 of the third section 17, as well as the choice of material, enable creating an elastic element 11 with different absolute values of constant static forces needed for different requirements for example depending on a static counter leverage force needed in a specific combustion engine. The absolute value of the elastic static force needed and generated by the elastic element 11 also depends on the position of the bolt 7 in the assembly 1, for example whether it is arranged close to the opening 10 of the injector cup 3 or whether the bolt 7 is arranged close to the elastic element 11. Therefore, it may depend on specific requirements how the elastic element 11 has to be manufactured.

What is claimed is:

1. An injector cup assembly comprising:
an injector cup and further comprising at least one bolt, and an elastic element for mechanically coupling the injector cup to a cylinder head of a combustion engine;
wherein, the injector cup has a longitudinal axis (L), the bolt is arranged through a penetrating first opening of the injector cup and arrangeable in an opening of the cylinder head to fasten the injector cup to the cylinder head; and
wherein the elastic element is mechanically coupled to the injector cup at a given position and configured to act against a tilt of the injector cup relative to the cylinder head by means of mechanical interaction with the bolt to generate a torque on the injector cup for pressing the injector cup to the cylinder head at a side opposite of the given position with respect to the penetrating first opening;
the elastic element comprising a first section, a second section adjacent to the first section and a third section adjacent to the second section, the first section being positioned at a distance from and substantially parallel to the third section and the second section being substantially perpendicular to the first and third section respectively,
wherein the third section effects said torque and comprises a spring area to generate an elastic force, and wherein the third section is positioned to be arranged between the injector cup and the cylinder head and contacts the injector cup at said given position, and is configured and positioned to be elastically deformed for generating the elastic force by means of fastening the injector cup to the cylinder head with the bolt.

2. The injector cup assembly of claim 1, wherein the first section of the elastic element comprises a penetrating opening in which the bolt is arranged to block an axial movement of the bolt in reference to the longitudinal axis (L).

3. The injector cup assembly of claim 2, wherein the injector cup comprises a penetrating second opening for receiving an injector which is positioned at said side opposite of the given position.

4. The injector cup assembly of claim 3, wherein the injector cup has a main portion which is shaped as a cylindrical shell and defines the penetrating second opening, and a beam portion which protrudes laterally from the main portion at one end thereof and comprises the penetrating first opening.

5. The injector cup assembly of claim 4, wherein the third section is positioned between the beam portion and the cylinder head.

6. The injector cup assembly of claim 5, wherein the third section comprises a wave-like spring shape and a penetrating opening.

7. The injector cup assembly of claim 6, wherein at least the first section and the third section of the elastic element contact the injector cup.

8. The injector cup assembly of claim 7, wherein the elastic element consists of bent sheet metal.

9. The injector cup assembly of claim 8, wherein the elastic element comprises a hook section configured to engage a recess of the injector cup to fasten the elastic element in a predetermined position relative to the injector cup.

10. The injector cup assembly of claim 9, wherein the hook section of the elastic element is arranged at an end of the third section that extends away from the second section of the elastic element.
